(19) United States
(12) Patent Application Publication
(10) Pub. No.: US 2011/0211455 A1
(43) Pub. Date: Sep. 1, 2011

(54) REPORT METHOD AND ACCESS CONTROL DEVICE AND RADIO DEVICE USING THE METHOD

(76) Inventors: Ken Nakaoka, Aichi (JP); Makoto Nagai, Gifu (JP); Keisuke Higuchi, Gifu (JP)

(21) Appl. No.: 13/060,903

(22) PCT Filed: Aug. 28, 2009
(86) PCT No.: PCT/JP2009/004222

§ 371 Date: May 17, 2011

(30) Foreign Application Priority Data
Aug. 29, 2008 (JP) 2008-222007
Sep. 5, 2008 (JP) 2008-228742
Sep. 8, 2008 (JP) 2008-229717

(51) Int. Cl. H04W 72/04; H04W 24/00

(52) U.S. Cl. 370/241; 370/329

(57) ABSTRACT

A frame specifying unit frames in such a manner that a frame containing at least a plurality of slots is repeated and in such a manner that a part of the plurality of slots contained in each frame are reserved for use on an access control apparatus. An empty slot identifying unit detects a slot, which is usable for the communications between radio apparatuses, from among the remaining part of the plurality of slots. A selection unit selects a slot from among the part of the plurality of slots in order to broadcast information on the detected slot. A modulation unit and an RF unit broadcast information on the slot detected by the empty slot identifying unit, using the selected slot.

### TECHNICAL FIELD

The present invention relates to a broadcasting technology and, more particularly, to a broadcasting method for broadcasting signals containing predetermined information and an access control apparatus and a radio apparatus both using said method.

### BACKGROUND TECHNOLOGY

Road-to-vehicle communication has been under investigation in an effort to prevent collision accidents of vehicles on a sudden encounter at an intersection. In a road-to-vehicle communication, information on conditions at an intersection is communicated between a roadside unit and an in-vehicle unit. Such a road-to-vehicle communication requires installation of roadside units, which means a great cost of time and money. In contrast to this, a vehicle-to-vehicle (inter-vehicular) communication, in which information is communicated between in-vehicle units, has no need for installation of roadside units. In that case, current position information is detected in real time by GPS (Global Positioning System) or the like and the position information is exchanged between the in-vehicle units. Thus it is determined on which of the roads leading to the intersection the driver's vehicle and the other vehicles are located (See Patent Document 1, for instance).

### PRIOR ART DOCUMENTS

### Patent Documents

[Patent Document 1] Japanese Unexamined Patent Application Publication No. 2005-202913.

Used in wireless LANs (Local Area Networks) conforming to standards, such as IEEE 802.11, is an access control function called Carrier Sense Multiple Access with Collision Avoidance (CSMA/CA). In such a wireless LAN, therefore, the same wireless channel is shared by a plurality of terminal apparatuses. Such CSMA/CA is subject to conditions involving mutual wireless signals not reaching the targets, namely, carrier sense not functioning, due to the effects of distance between the terminal apparatuses or obstacles attenuating the radio waves and so forth. When the carrier sense does not function, there occur collisions of packet signals transmitted from a plurality of terminal apparatuses. Also, wireless LANs employ the OFDM modulation scheme to achieve faster communication speed.

On the other hand, when a wireless LAN is applied to the inter-vehicular communication, a need arises to transmit information to a large indefinite number of terminal apparatuses, and therefore it is desirable that signals be sent by broadcast. Yet, at an intersection or like places, an increase in the number of vehicles, that is, the number of terminal apparatuses, is considered to cause an increase in the collisions of the packet signals therefrom. In consequence, data contained in the packet signals may not be transmitted to the other terminal apparatuses. If such a condition occurs in the inter-vehicular communication, then the objective of preventing collision accidents of vehicles on a sudden encounter at an intersection will not be attained.

The present invention has been made in view of the foregoing circumstances, and the purpose thereof is to provide a technology for reducing the collision probability of packet signals under conditions of increased volume of communication.

### MEANS FOR SOLVING THE PROBLEMS

In order to resolve the above problems, an access control apparatus according to one embodiment of the present invention controls communications between terminal apparatuses and it includes: a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; a selection unit configured to select a slot from among the part of the plurality of slots wherein the slot selected by the selection unit is used to broadcast information on the slot detected by the detecting unit; and a broadcasting unit configured to broadcast information on the slot detected by the detecting unit, using the slot selected by the selection unit.

Another embodiment of the present invention relates to a broadcasting method. This method is a broadcasting method in an access control apparatus that controls communications between radio apparatuses and it includes: detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; selecting a slot from among the part of the plurality of slots in order to broadcast information on the detected slot; and broadcasting information on the detected slot detected, using the selected slot.

Still another embodiment of the present invention relates to an access control apparatus. This apparatus is an access control apparatus for controlling communications between radio apparatuses and it includes: a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; a selection unit configured to select a slot from among the part of the plurality of slots in order to broadcast empty slot information on the slot detected by the detecting unit; and a broadcasting unit configured to broadcast the empty slot information and identification information by which to identify the access control apparatus, using the slot selected by the selection unit.

Still another embodiment of the present invention relates to a radio apparatus. This apparatus is a radio apparatus for broadcasting a signal to other radio apparatuses and the radio apparatus including: a receiver configured to receive from an access apparatus, a signal that contains (1) empty slot information on slots usable in communication between radio apparatuses and (2) identification information by which to identify the access control apparatus which is a broadcasting source, using a slot contained in a plurality of slots which are contained in a frame, a part of which are reserved for use on the access control apparatus, wherein it is specified in a manner such that the frame containing at least a plurality of slots is repeated; a selection unit configured to select a slot from among the remaining part of the plurality of slots, based on the empty slot information contained in the signal received by the receiver; and a broadcasting unit configured to broadcast the signal by adding (1) the identification information contained in the signal received by the receiver and (2) broadcast slot information on a slot through which the signal received by the receiver has been broadcast.

Still another embodiment of the present invention relates to a broadcasting method. This method is a broadcasting method in an access control apparatus that controls communications between radio apparatuses and includes: detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; selecting a slot from among the part of the plurality of slots in order to broadcast empty slot information on the selected slot; and broadcasting the empty slot information and identification information by which to identify the access control apparatus, using the selected slot.

Still another embodiment of the present invention relates also to a broadcasting method. This is a broadcasting method in a radio apparatus that broadcasts a signal to other radio apparatuses, and it includes: receiving from an access apparatus, a signal that contains

(1) empty slot information on slots usable in communication between radio apparatuses and (2) identification information by which to identify the access control apparatus which is a broadcasting source, using a slot contained in a plurality of slots which are contained in a frame, a part of which are reserved for use on the access control apparatus, wherein it is specified in a manner such that the frame containing at least a plurality of slots is repeated; selecting a slot from among the remaining part of the plurality of slots, based on the empty slot information contained in the received signal; and broadcasting the signal by adding (1) the identification information contained in the received signal and (2) broadcast slot information on a slot through which the received signal has been broadcast.

Still another embodiment of the present invention relates to an access control apparatus. This apparatus is an access control apparatus for controlling communications between radio apparatuses and it includes: a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; a selection unit configured to select a slot from among the part of the plurality of slots in order to broadcast empty slot information on the slot detected by the detecting unit; and a broadcasting unit configured to broadcast the empty slot information and identification information by which to identify the access control apparatus, using the slot selected by the selection unit. The selection unit includes: an acquisition unit configured to receive from a radio apparatus a signal, used in communications between radio apparatuses, which contains (i) the identification information of an access control apparatus that has broadcast the empty slot information referenced by the radio apparatus and (ii) broadcast slot information on a slot through which the empty slot information referenced by the radio apparatus has been broadcast; an analysis unit configured to statistically analyze the identification information and the broadcast slot information contained in the signal received by the acquisition unit; an estimation unit configured to estimate slots not used by other access apparatuses in the part of the plurality of slots, based on an analysis result derived by the analysis unit; and an execution unit configured to select a slot based on an estimation result of the estimation unit.

Still another embodiment of the present invention relates also to an access control apparatus. This apparatus is an access control apparatus for controlling communications between radio apparatuses and it includes: a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; a selection unit configured to select a slot from among the part of the plurality of slots in order to broadcast empty slot information on the slot detected by the detecting unit; and a broadcasting unit configured to broadcast the empty slot information and identification information by which to identify the access control apparatus, using the slot selected by the selection unit. The selection unit includes: an acquisition unit configured to receive from a radio apparatus a signal, used in communications between radio apparatuses, which contains (i) position information indicating where an access control apparatus that has broadcast the empty slot information referenced by the radio apparatus is installed and (ii) broadcast slot information on a slot through which the empty slot information referenced by the radio apparatus has been broadcast an estimation unit configured to estimate slots not used by other access apparatuses located in a neighborhood of said access control apparatus, based on identification information and the broadcast slot information contained in the signal received by the acquisition unit; and an execution unit configured to select a slot based on an estimation result of the estimation unit.

Still another embodiment of the present invention relates to a broadcasting method. This method is a broadcasting method in an access control apparatus that controls communications between radio apparatuses and it includes: detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated; selecting a slot from among the part of the plurality of slots in order to broadcast empty slot information on the detected slot; and broadcasting the empty slot information and identification information by which to identify the access control apparatus, using the selected slot. The selecting includes: receiving from a radio apparatus a signal, used in communications between radio apparatuses, which contains (i) the identification information of an access control apparatus that has broadcast the empty slot information referenced by the radio apparatus and (ii) broadcast slot information on a slot through which the empty slot information referenced by the radio apparatus has been broadcast; analyzing statistically the identification information and the broadcast slot information contained in the received signal; estimating slots not used by other access apparatuses in part of the plurality of slots, based on an analysis result derived the analyzing; and selecting a slot based on an estimation result obtained by the estimating.

Still another embodiment of the present invention relates also to a broadcasting method. This method is a broadcasting method in an access control apparatus that controls communications between radio apparatuses and it includes: detecting a slot, which is usable for the communications between radio apparatuses, from among a plurality of slots, contained in a frame, excluding a part of the plurality slots which are reserved exclusively for use on an access control apparatus, wherein it is specified in a manner such that the frame containing at least a plurality of slots is repeated; selecting a slot from among the part of the plurality of slots excluding a part of thereof which are reserved exclusively for use on the access control apparatus, in order to broadcast empty slot information on the detected slot; and broadcasting the empty slot information and identification information by which to identify the access control apparatus, using the selected slot. The selecting includes: receiving from a radio apparatus a signal, used in communications between radio apparatuses, which contains (i) position information indicating where an access control apparatus that has broadcast the empty slot information referenced by the radio apparatus is installed and (ii) broadcast slot information on a slot through which the empty slot information referenced by the radio apparatus has been broadcast; estimating slots not used by other access apparatuses located in a neighborhood of the access control apparatus, based on identification information and the broadcast slot information contained in the received signal; and selecting a slot based on an estimation result derived by the estimating.

Optional combinations of the aforementioned constituting elements, and implementations of the invention in the form of methods, apparatuses, systems, recording media, computer programs and so forth may also be practiced as additional modes of the present invention.

### EFFECT OF THE INVENTION

The present invention reduces the collision probability of packet signals under conditions of increased volume of communication.

### BRIEF DESCRIPTION OF THE DRAWINGS

FIG. 1 shows a structure of a communication system according to an exemplary embodiment of the present invention.

FIG. 2 shows another structure of a communication system according to an exemplary embodiment of the present invention.

FIG. 3 shows a structure of an access control apparatus of FIG. 1 and FIG. 2.

FIGS. 4A to 4D show formats of frames specified by a frame specifying unit of FIG. 3.

FIGS. 5A and 5B show formats of OFDM symbol used in the communication system of FIG. 1 and FIG. 2, respectively.

FIG. 6 shows a structure of a terminal apparatus mounted on a vehicle of FIG. 1.

FIG. 7 shows an operational overview of the communication system of FIG. 1 and FIG. 2.

FIG. 8 shows another operational overview of the communication system of FIG. 1 and FIG. 2.

FIG. 9 shows still another operational overview of the communication system of FIG. 1 and FIG. 2.

FIG. 10 is a flowchart showing a procedure in which the access control apparatus of FIG. 3 selects a control slot.

FIG. 11 is a flowchart showing a procedure in which a control slot is selected by carrier sense of FIG. 10.

FIG. 12 is a flowchart showing a procedure in which a control slot is selected using control slot information and identification information of FIG. 10.

FIG. 13 is a flowchart showing a procedure in which the access control apparatus of FIG. 3 conveys an empty slot.

FIG. 14 is a flowchart showing a procedure in which the access control apparatus of FIG. 3 conveys a collision slot.

FIG. 15 is a flowchart showing a data transmission procedure performed by the terminal apparatus of FIG. 6.

FIG. 16 shows a procedure, according to a modification of an exemplary embodiment of the present invention, in which a control slot is selected using control slot information and identification information.

### BEST MODE FOR CARRYING OUT THE INVENTION

The present invention will be outlined before it is explained in detail. Exemplary embodiments of the present invention relate to a communication system carrying out data communication between terminal apparatuses installed in vehicles. A terminal apparatus transmits, by broadcast, packet signals containing information such as the traveling speed and position of a vehicle (hereinafter referred to as “data”). And the other terminal apparatuses receive the packet signals and recognize the approach or the like of the vehicle based on the data. Note here that the terminal apparatuses employ the OFDM modulation scheme to achieve faster communication speed. Under these circumstances, an increase in the number of terminal apparatuses at an intersection or like place increases the probability of packet signals occurring. To cope with it, the communication system according to the present exemplary embodiment executes the following processes.

The communication system according to the present exemplary embodiment includes an access control apparatus in addition to a plurality of terminal apparatuses, and the access control apparatus is installed at an intersection, for instance. The access control apparatus repeatedly specifies a frame that contains a plurality of slots. Note that a part of the plurality of frames contained in each frame are reserved and secured as control slots. The access control apparatus identifies slots not used in communication among a plurality of terminal terminals (hereinafter referred to as “empty slots” or “unused slots”) by measuring the received power in each slot. Note also that those which may be assigned as the empty slots are those excluding the control slots.

Also, the access control apparatus adds frame constituent information and information on the identified slots to control information and transmits, by broadcast, a packet signal containing the control information (hereinafter referred to sometimes as “control information” also) using a single slot. It is to be understood here that the single slot is one selected from among the control slots. A terminal apparatus selects any of the empty slots based on the control information and transmits, by broadcast, a packet signal containing data (hereinafter referred to sometimes as “data” also) using the selected slot. Note that the terminal apparatus, when transmitting data over a plurality of frames, uses the same slots in corresponding timing in each frame.

The access control apparatus identifies slots having any collision (hereinafter referred to as “collision slots”) by also measuring in each slot for any collision of packet signals transmitted by a plurality of terminal apparatuses. Note also that those which may be identified as the collision slots are those excluding the control slots. The access control apparatus also adds information on the identified slots to the control information. A terminal apparatus checks for the presence of any collision in the already used slots, based on the control information. When there is any collision, the terminal apparatus selects any one of the other empty slots, based on the control information. Note here that the access control apparatus has no direct involvement in data communication between terminal apparatuses, that is, the access control apparatus does not directly specify the slot to be used in the data communication. In other words, the access control apparatus monitors the condition of data communication between terminal apparatuses and keeps broadcasting information on unused slots and collision slots. That is, the access control apparatus controls the communications between a plurality of terminal apparatuses.

It is to be noted that since the control information is also transmitted in a single slot, there are chances that the data transmitted from a terminal apparatus incapable of receiving the control information may collide with the control information. In consequence, if the other terminal apparatuses cannot receive the control information, then there arises a difficulty of carrying out the aforementioned processes. To cope with this situation, the OFDM signals used in transmitting data have some of the subcarriers as null carriers in which no data is contained (these subcarriers being hereinafter referred to as “identification carriers”). On the other hand, the OFDM signals used in transmitting control information have signals placed in the identification carriers, too. Hence, even when there is a collision between data and control information, the terminal apparatus can detect the presence of control information by observing the signal components of the identification carrier.

Further, if a plurality of access apparatuses are installed at an intersection where they are located close to each other, interference between them must be taken into consideration. If, for instance, the control information transmitted by broadcast from the plurality of access control apparatuses installed at the intersection interfere with each other, the terminal apparatuses may not be able to receive the control information and therefore the aforementioned processes will not be achieved. Though such interference can be avoided by assigning a different frequency channel to each access control apparatus, another separate structure to reduce the interference will be needed if no other frequency chancel can be provided. Each access apparatus performs carrier sense on a plurality of control slots, respectively, and thereby it selects one control slot and transmits, by broadcast, the control information using the selected control slot.

If, however, the control slot is selected by performing the carrier sense, other access control apparatuses may possibly not be recognized depending on the position where the access control apparatuses are installed. In other words, a phenomenon similar to the hidden node problem occurs. To cope with this, each access apparatus broadcasts the control information by adding information with which to identify said access apparatus (hereinafter referred to as “identification information”) thereto. Each terminal apparatus transmits, by broadcast, data in such manner that both (i) the information on a control slot where the control information has been transmitted (hereinafter referred to as “control slot information”) and (ii) the information on the identification information are added to the data. The access control apparatus receives this data and thereby it recognizes the control slot used by the other access control apparatuses. Also, the access control apparatus selects the control slot in view of the recognized control slot as well.

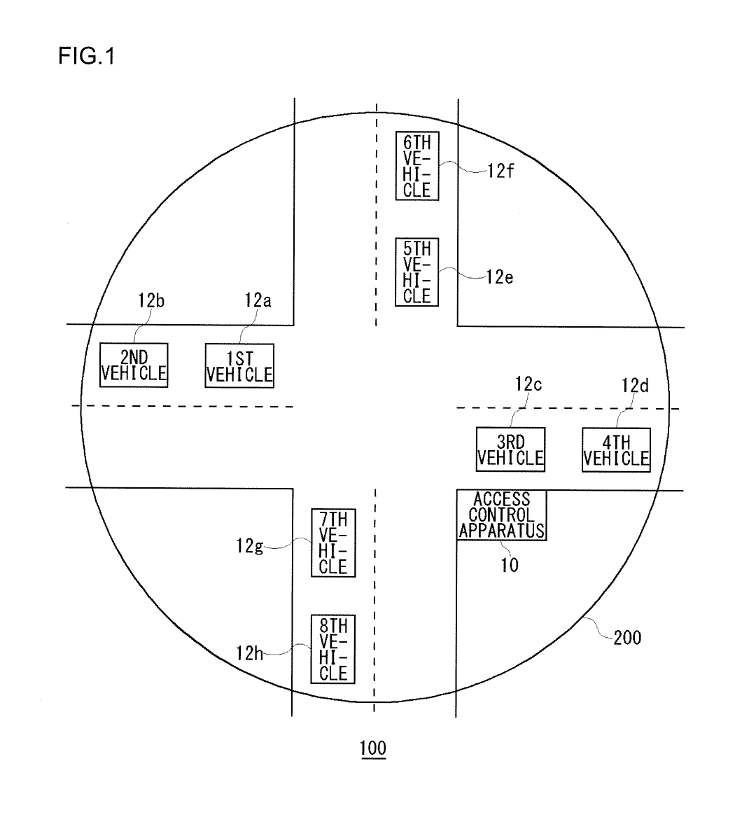

FIG. 1 shows a structure of a communication system 100 according to an exemplary embodiment of the present invention. FIG. 1 corresponds to a case thereof at an intersection viewed from above. The communication system 100 includes an access control apparatus 10 and a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h, which are generically referred to as “vehicle 12” or “vehicles 12”. It is to be noted that each vehicle 12 has a not-shown terminal apparatus installed therein. Also, an area 200 is formed by the access control apparatus 10.

As shown in FIG. 1, a road extending in the horizontal, or left-right, direction and a road extending in the vertical, or up-down, direction in FIG. 1 intersect with each other in the central portion thereof. Note here that the upper side of FIG. 1 corresponds to the north, the left side thereof the west, the down side thereof the south, and the right side thereof the east. And the portion where the two roads intersect each other is the intersection. The first vehicle 12a and the second vehicle 12b are advancing from left to right, while the third vehicle 12c and the fourth vehicle 12d are advancing from right to left. Also, the fifth vehicle 12e and the sixth vehicle 12f are advancing downward, while the seventh vehicle 12g and the eighth vehicle 12h are advancing upward.

The terminal apparatus installed in each of the vehicles 12 acquires data and transmits, by broadcast, a packet signal containing the data. Here, before explaining exemplary embodiments of the present invention, a description will be given of an operation of a terminal apparatus which is compatible with a known wireless LAN, i.e., CSMA/CA. Each terminal apparatus transmits data by broadcast when it has determined by executing carrier sense that transmission is possible. Consequently, there are chances of data from a plurality of terminal apparatuses colliding with each other. Also, as the number of terminal apparatuses increases, there will be greater probability of collisions occurring. In particular, at locations like intersections, the likelihood of data collision is greater despite the fact that the likelihood of vehicles 12 colliding with each other is also great. This means failed utilization of data in spots where data is in the greatest demand.

Therefore, the communication system 100 places an access control apparatus 10 at each intersection. The access control apparatus 10 generates a frame containing a plurality of slots repeatedly based on the signals received from not-shown GPS satellites. Also, the access control apparatus 10 identifies empty slots and collision slots out of the plurality of slots. The method for identifying the empty slots and collision slots will be discussed later. The access control apparatus 10 adds information on the identified empty slots and collision slots to the control information. Further, the access control apparatus 10 broadcasts the control information, using any of a pluraliyt of control slots. The selection of the control slot(s) will be discussed later.

A plurality of terminal apparatuses receive the control information broadcast by the access control apparatus 10 and selects one of the empty slots. Also, each terminal apparatus broadcasts data, using a selected slot. Note here that the terminal apparatus broadcasts the data, using a slot corresponding to the selected slot for a plurality of frames. For example, when a tenth slot from the top of a frame has been selected, it is the tenth slot from the top of a frame that must be used for the next frame also. It is to be noted that when there is an indication in the control information that the slot being used is a collision slot, the terminal apparatus further selects another empty slot. The terminal apparatus repeats the above-described processing for the duration in which the terminal apparatus can receive the control information broadcast by the access control apparatus 10. In other words, the terminal apparatus watches for control information and detects its entry in the area 200 when the terminal apparatus has received the control information. It is to be appreciated that the terminal apparatus can broadcast data even when the terminal apparatus is not receiving control information. The terminal apparatus which has received data from the other terminal apparatuses recognizes, based on the data, the presence of vehicles 12 that are carrying the other terminal apparatuses

Note here that both the control information broadcast from the access control apparatus 10 and the data broadcast from the terminal apparatuses use OFDM signals. However, it is not the same subcarriers in which the control information and the data are placed. The data is not placed in the aforementioned identification carriers. On the other hand, identification information is placed not only in the subcarriers where the data is placed but also in the identification carriers. As a result, even when there is a collision between data and identification information, the terminal apparatus can detect the presence of control information by observing the signal components of identification carriers. It should be noted that the aforementioned detection of entry into the area 200 by the terminal apparatus may be made relative to the identification carriers.

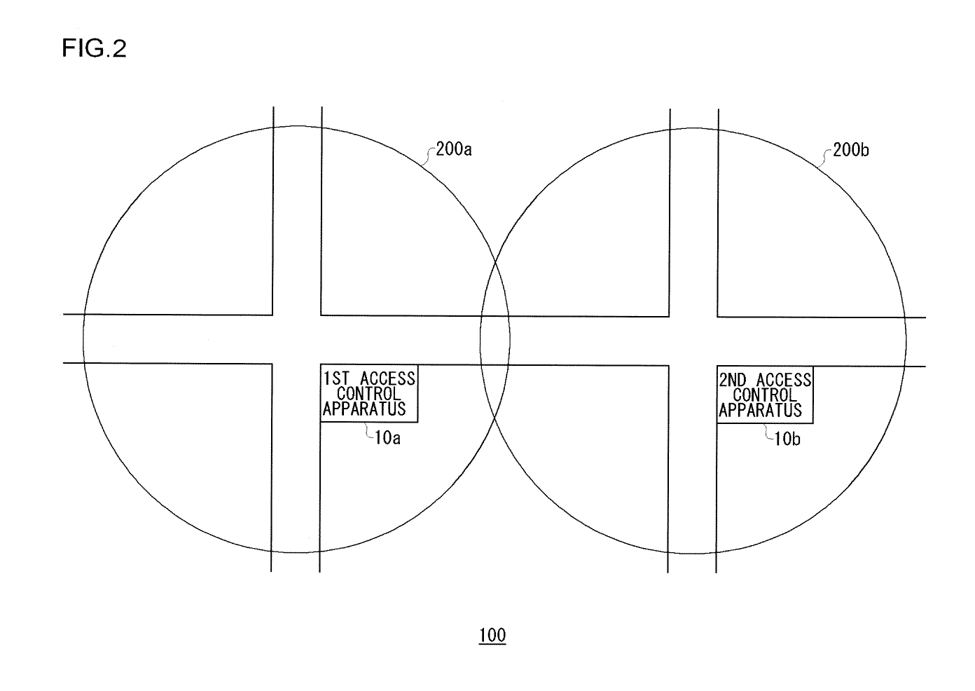

FIG. 2 shows another structure of the communication system 100 according to the exemplary embodiment of the present invention. FIG. 2 shows a case where the intersections each of which is as shown in FIG. 1 are placed side by side. A first access control apparatus 10a and a second access control apparatus 10b are installed in the intersections, respectively. For clarity of FIG. 2, the vehicles 12 shown in FIG. 1 are omitted in FIG. 2. As shown in FIG. 2, a first area 200a is formed by the first access control apparatus 10a, whereas a second area 200b is formed by the second access control apparatus 10b. Also, the first area 200a and the second area 200b partially overlaps with each other. If a not-shown vehicle 12 exists in this partially overlapped area, the terminal apparatus installed in this vehicle 12 can receive control information broadcast from the first access control apparatus 10a and control information broadcast from the second access control apparatus 10b. Required therefore is a structure by which to reduce the interference for the control information broadcast from the two access control apparatuses 10.

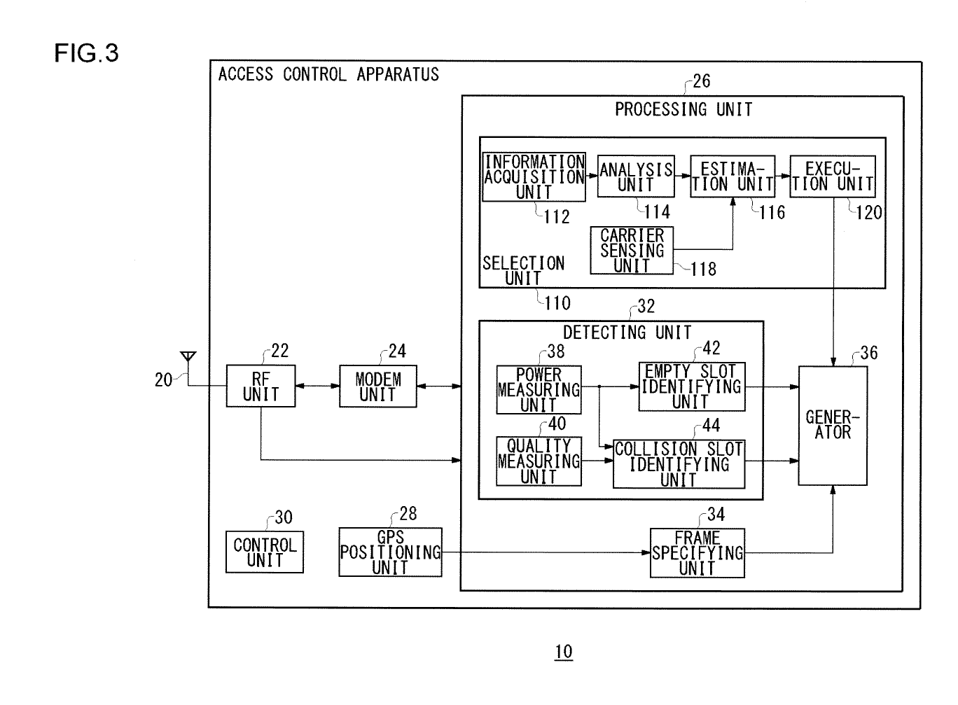

FIG. 3 shows a structure of the access control apparatus 10. The access control apparatus 10 includes an antenna 20, an RF unit 22, a modem unit 24, a processing unit 26, a GPS positioning unit 28, and a control unit 30. The processing unit 26 includes a detecting unit 32, a frame specifying unit 34, a generator 36, and a selection unit 110. The detecting unit 32 includes a power measuring unit 38, a quality measuring unit 40, an empty slot identifying unit 42, and a collision slot identifying unit 44. The selection unit 110 includes an information acquisition unit 112, an analysis unit 114, an estimation unit 116, a carrier sensing unit 118, and an execution unit 120.

The GPS positioning unit 28 receives signals from not-shown GPS satellites and acquires information on the time of day based on the received signals. It should be noted that known art can be used for the acquisition of information on the time of day and therefore the description thereof is omitted here. The GPS positioning unit 28 outputs the information on the time of day to the frame specifying unit 34. The frame specifying unit 34 acquires information on the time of day from the GPS positioning unit 28. The frame specifying unit 34 generates a plurality of frames based on the information on the time of day. For example, the frame specifying unit 34 generates ten “100 msec” frames by dividing a duration of “1 sec” into 10 parts from the timing of “0 msec”. Frames are thus defined and specified repeatedly through the repetition of this process.

Also, the frame specifying unit 34 generates a plurality of slots by dividing each frame into a plurality of parts. For example, dividing a frame into 200 parts generates 200 slots with each slot being “500 μsec” long. Here, a part of a plurality of slots contained in each frame is reserved as “control slots”. For example, first five slots from the beginning of 200 slots contained in each frame are control slots. Also, the control slot may be thought of as a slot used when the access control apparatus 10 broadcasts control information. As previously indicated, since the communication system 100 employs the OFDM modulation scheme, each slot is so specified as to be composed of a plurality of OFDM symbols. Also, an OFDM symbol comprises a guard interval (GI) and a valid symbol. Note that a guard time may be provided in the front portion and the rear portion of each slot. It is to be noted also that a certain group of or combination of a plurality of OFDM symbols contained in a slot is equivalent to the packet signal mentioned earlier.

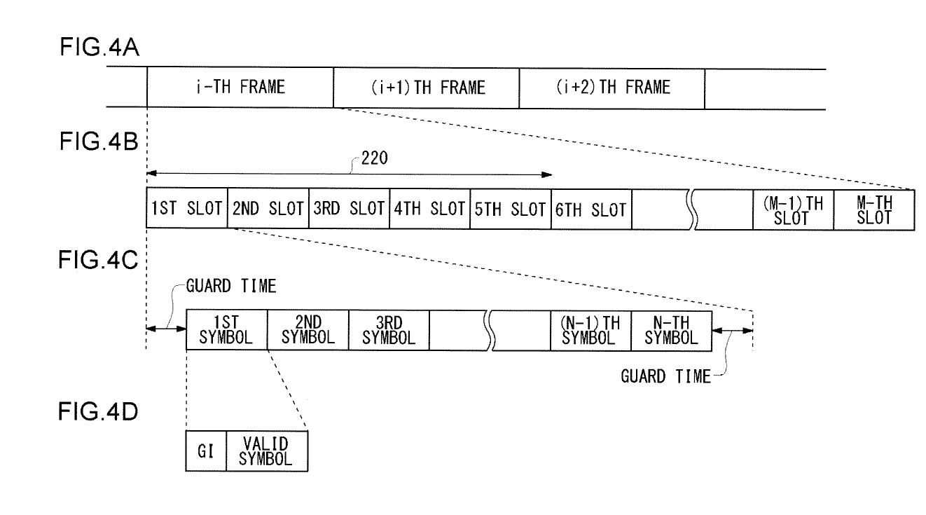

FIGS. 4A to 4D show the formats of frames specified by the frame specifying unit 34. FIG. 4A shows a structure of frames. As shown in FIG. 4A, a plurality of frames, such as i-th frame to (i+2)th frame, are so specified as to be repeated. Also, the duration of each frame is “100 msec”, for instance. FIG. 4B shows a structure of a single frame. As shown in FIG. 4B, a single frame consists of M units of slots. For example, M is “200” and the duration of each slot is “500 μsec”. Also, slots assigned to the beginning part of each frame correspond to the control slots, and an interval where the control slots are assigned is indicated as a control region 220.

In this case, five slots which are a first slot to a fifth slot are contained in the control region 220 as the control slots. FIG. 4C shows a structure of a single slot. As shown in FIG. 4C, a guard time may be provided in the front portion and the rear portion of each slot. And the remaining duration of the slot consists of N units of OFDM symbols. FIG. 4D shows a structure of each OFDM symbol. As shown in FIG. 4D, each OFDM symbol consists of a GI and a valid symbol. Let us now refer back to FIG. 3.

The RF unit 22 receives through the antenna 20 a packet signal transmitted in communication between the other terminal apparatuses (not shown) in each slot, as a receiving processing. The RF unit 22 also receives packet signals containing the control information sent from not-shown other access control apparatuses 10, in each control slot contained in the control region 220. The RF unit 22 performs a frequency conversion on the packet signal of a radiofrequency received through the antenna 20 and thereby generates a packet signal of baseband. Further, the RF unit 22 outputs the baseband packet signal to the modem unit 24. Generally, a baseband packet signal is formed of an in-phase component and a quadrature component, and therefore it should be represented by two signal lines. However, it is represented by a single signal line here to make the illustration clearer for understanding.

Also, the RF unit 22 includes an LNA (Low Noise Amplifier), a mixer, an AGC unit, and an A-D conversion unit. The RF unit 22 performs a frequency conversion on the baseband packet signal inputted from the modem unit 24 and thereby generates a radiofrequency packet signal in each slot as a transmission processing. Further, the RF unit 22 transmits, through the antenna 20, the radiofrequency packet signal. The RF unit 22 also includes a PA (Power Amplifier), a mixer, and a D-A conversion unit.

The modem unit 24 demodulates the radiofrequency packet signal fed from the RF unit 22, as a receiving processing. Further, the modem unit 24 outputs the demodulation result to the processing unit 26. Also, the modem unit 24 modulates the data fed from the processing unit 26, as a transmission processing. Further, the modem unit 24 outputs the modulation result to the RF unit 22 as a baseband packet signal. It is to be noted here that the communication system 100 is compatible with the OFDM modulation scheme and therefore the modem unit 24 performs FFT (Fast Fourier Transform) as a receiving processing and performs IFFT (Inverse Fast Fourier Transform) as a transmission processing also.

The carrier sensing unit 118 conducts carrier sense in the control region 220 for each control slot. That is, the control region 220 receives a received signal from the RF unit 22 or the modem unit 24 on a control slot by control slot basis, and measures the received power. As a result, the carrier sensing unit 118 measures the received power for each of the plurality of control slots. Also, the carrier sensing unit 118 stores a threshold value for control slot in advance and compares the received power against the threshold value for control slot for each control slot. The carrier sensing unit 118 selects a control slot whose received power is less than the threshold value for control slot. The carrier sensing unit 118 outputs the number of the selected control slot to the estimation unit 116.

The information acquisition unit 112 receives a packet signal used for communications between a plurality of terminal apparatuses (not-shown), namely the packet signal transmitted, by broadcast, from a predetermined terminal apparatus. Note that the information acquisition unit 112 receives the packet signal using slots other than those contained in the control region 220 in a frame. The packet signal contains identification information and control slot information. The control information is information with which to identify an access control apparatus 10 that has broadcast the control information referenced by a terminal apparatus that has transmitted this packet signal. A precondition in this case is that the identification information is contained in the control information which is broadcast-transmitted by each access control apparatus 10.

Also, the identification information corresponds to the position information set by the access control apparatus 10. For instance, the position information is indicated by the latitude and longitude, and the latitude and longitude may be used as the identification information. The control information is information on a control slot or control slots through which the control information referenced by the terminal apparatus that has transmitted said packet signal is broadcast, and corresponds to the slot number where the control information is assigned. For example, the control slot information is indicated like a “second slot” in FIG. 4B. The information acquisition unit 112 outputs the identification information and the control slot information to the analysis unit 114.

The analysis unit 114 sequentially acquires combinations of identification information and control slot information from the information acquisition unit 112. The analysis unit 114 statistically analyzes the combinations of identification information and control slot information. More specifically, the analysis unit 114 accumulates the number of acquisitions for each combination over a predetermined period of time. Also, the analysis unit 114 determines beforehand a threshold value for the number of acquisitions, and compares the number of acquisitions against the threshold value for the number thereof for each combination. Further, the analysis unit 114 extracts a combination or combinations corresponding to the number of acquisitions which is larger than the threshold value for the number thereof.

The analysis unit 114 derives the position information from the identification information contained in each combination. Also, the analysis unit 114 stores, in advance, the position information where the access control apparatus 10 is installed, and derives the distance between access control apparatuses based on their position information. Further, the analysis unit 114 stores beforehand a threshold value for distance, and compares the distance against the threshold value for distance. The analysis unit 114 excludes a combination of identification information and control slot information for an access control apparatus 10 whose distance is larger than the threshold value for distance, namely the combination thereof for an access control apparatus 10 installed farther than said access control apparatus by the threshold value for distance or greater, from the accumulation process. The analysis unit 114 outputs the extracted combination or combinations to the estimation unit 116.

The estimation unit 116 receives the number of the selected control slot from the carrier sensing unit 118 and, at the same time, receives the combination extracted as the analysis result from the analysis unit 114, too. The analysis unit 114 identifies control slots which are not used by other access control apparatuses 10, based on the control slot information contained in the combination. More specifically, control slots other than those having the slot numbers indicated by the control slot information are identified. Further, the estimation unit 116 estimates a control slot in the control region 220 which is not used by other access control apparatuses, based on the identified control slot and the control slot selected by the carrier sensing unit 118. More specifically, the identified control slot which is selected by the carrier sensing unit 118 is the control slot which is not being used. Here, the control slot not being used may be in plurality. The estimation unit 116 outputs an estimation result to the execution unit 120.

The execution unit 120 receives the estimation result from the estimation unit 116 and selects one control slot from among those not being used. The control slot may be selected by using an arbitrary method. That is, to broadcast the control information, the execution unit 120 selects one control slot from those contained in the control region 220. The antenna 20 transmits the information on the selected control slot to the generator 36.

The power measuring unit 38 receives a received signal from the RF unit 22 or the modem unit 24 and measures the received power. Also, slots correspond to slots other than the control slots. The received power herein is measured slot by slot. Hence, the power measuring unit 38 measures the received power for each of the plurality of slots. The power measuring unit 38 outputs the received power for each slot to the empty slot identifying unit 42, and the collision slot identifying unit 44. The quality measuring unit 40 receives the demodulation result from the modem unit 24 and measures the signal quality for each of the plurality of slots. The signal quality measured herein is the error rate. Here, slots correspond to slots other than the control slots, too. It should be noted that known art can be used for the measurement of the error rate, so that the description thereof is omitted here. Also, instead of the error rate, EVM (Error Vector Magnitude) or the like may be measured as the signal quality. The quality measuring unit 40 outputs the error rate to the collision slot identifying unit 44.

The empty slot identifying unit 42 receives the received power for each slot from the power measuring unit 38. The empty slot identifying unit 42 compares each received power against a threshold value (hereinafter referred to as “threshold value for empty slot”) and identifies the slot for which the received power is smaller than the threshold value for empty slot. That is, the empty slot identifying unit 42 detects, from among a plurality of slots other than those contained in the control region 220, a slot that can be used in communication between a plurality of terminal apparatuses, as an empty slot. Note here that when there are a plurality of empty slots, the empty slot identifying unit 42 identifies them as empty slots. The empty slot identifying unit 42 outputs information on the identified empty slots to the generator 36.

The collision slot identifying unit 44 receives the received power for each slot from the power measuring unit 38 and receives the error rate for each slot from the quality measuring unit 40. Also, the collision slot identifying unit 44 associates the received power with the error rate, slot by slot. The collision slot identifying unit 44 compares not only the received power against a first threshold value, but also the error rate against a second threshold value, slot by slot. The collision slot identifying unit 44 identifies, as a collision slot, a slot for which the received power is larger than the first threshold value and at the same time the error rate is higher than the second threshold value. That is, the collision slot identifying unit 44 recognizes, as a collision slot, a slot for which the received power is large but the communication quality is inferior. In this manner, the collision slot identifying unit 44 detects, as a collision slot, a slot in which a collision has occurred due to duplicate transmission of signals sent from a plurality of terminal apparatuses. The collision slot identifying unit 44 outputs information on the identified collision slots to the generator 36.

The generator 36 receives information on empty slots from the empty slot identifying unit 42 and also receives information on collision slots from the collision slot identifying unit 44. The generator 36 generates control information by adding the information on empty slots and the information on collision slots thereto. Note here that the numbers, 1, 2, . . . from the start (hereinafter referred to as “slot numbers”) are given respectively to a plurality of slots contained in a frame. The generator 36 adds the slot number(s) of the empty slot(s) contained in the previous frame(s) as information on empty slots to the control information.

Also, the generator 36 adds the slot number(s) of the collision slot(s) contained in the previous frame(s) as information on collision slots to the control information. In addition to these, the generator 36 stores the identification information on the access control apparatus 10 and adds this identification information to the control information; further, the generator 36 receives information on control slots from the execution unit 120 and also adds the information on control slots to the control information. The identification information has been previously explained and the description thereof is omitted here. Further, the generator 36 receives the information on frames and slots from the frame specifying unit 34. The generator 36 periodically assigns the control information to a control slot indicated in the information on control slots. The generator 36 outputs the control information to the modem unit 24, using the thus assigned control slot.

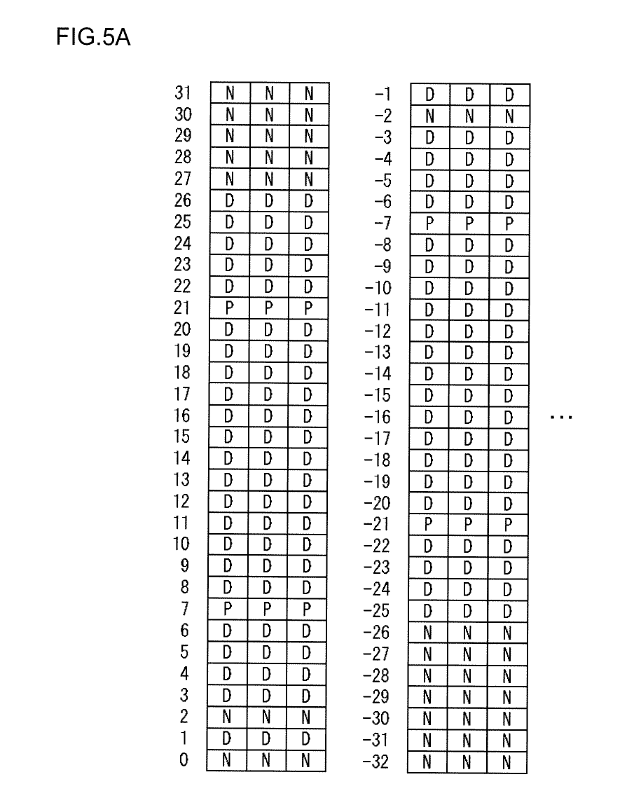

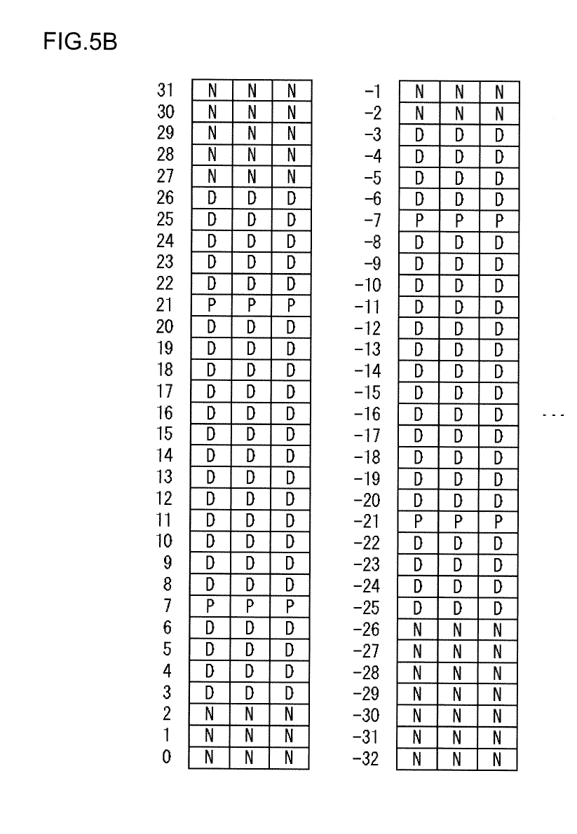

As described above, the communication system 100 is compatible with the OFDM modulation scheme and therefore the generator 36 generates the control information as an OFDM signal. Note here that the OFDM signals are also used for the communications between a not-shown plurality of terminal apparatuses. A description is given herein by comparing an OFDM signal that has the control information assigned (hereinafter this is called “control information” also) with an OFDM signal that has data assigned (hereinafter this is called “data” also). FIGS. 5A and 5B illustrate formats of OFDM symbols used in the communication system 100. FIG. 5A corresponds to control information, whereas FIG. 5B corresponds to data.

In both FIG. 5A and FIG. 5B, the vertical direction represents the frequency, whereas the horizontal direction represents time. The numbers “31”, “30”, . . . , “−32” are indicated from top along the vertical direction, and these are the numbers assigned to identify subcarriers (hereinafter referred to as “subcarrier numbers”). In OFDM signals, the frequency of a subcarrier whose subcarrier number is “31” is the highest, whereas the frequency of a subcarrier whose subcarrier number is “−32” is the lowest. In FIG. 5A and FIG. 5B, “D” corresponds to a data symbol, “P” a pilot symbol, and “N” a null.

What are common to the control information and the data are the subcarrier numbers “31” to “27”, “2”, “0”, and “−2”, and the subcarrier numbers “−26” to “−32” which are all null. Of the control information, the subcarrier numbers “26” to “3”, “−3” to “−25” are also used in data, and the use of symbols is the same for both the control information and the data. of the control information, on the other hand, the subcarrier numbers “1” and “−1” are not used for data. These correspond to the aforementioned identification carriers. That is, the identification carrier is assigned to a subcarrier near the center frequency of an OFDM signal. Of the control information, a guard band is provided between a subcarrier used also for data and the identification carrier, namely between the subcarrier number “2” and the subcarrier number “−2”. The subcarriers of the subcarrier number “−2” through the subcarrier number “2” may be collectively called “identification carrier” or “identification carriers”.

The generator 36 assigns the information on empty slots and the information on collision slots to subcarriers other than the identification carriers of the control information. Also, the generator 36 assigns the information on frames to the identification carrier. Also, the generator 36 may preferentially assign not only these items of information but also information having higher degrees of importance to the identification carrier. Also, a known signal is assigned to an OFDM symbol which is located anterior to the packet signal. Such a known signal is used for AGC (Automatic Gain Control) or used to estimate the channel characteristics. The generator 36 may assign a known signal to the identification carrier over a partial period of a predetermined slot. Such a known signal is used as a unique word (UW), for example. Let us now refer back to FIG. 3.

The control information generated in the modem unit 24, the RF unit 22 and the generator 36 are broadcast from the antenna 20. A terminal apparatus, which uses slots corresponding to the information on empty slots and information on the collision slots both contained in the control information, uses slots corresponding to said slots over a plurality of frames. For example, a slot whose slot number is “10” is used continuously. The control unit 30 controls the entire processing of the access control apparatus 10.

These structural components may be implemented hardwarewise by elements such as a CPU, memory and other LSIs of an arbitrary computer, and softwarewise by memory-loaded programs or the like. Depicted herein are functional blocks implemented by cooperation of hardware and software. Therefore, it will be obvious to those skilled in the art that the functional blocks may be implemented by a variety of manners including hardware only, software only or a combination of both.

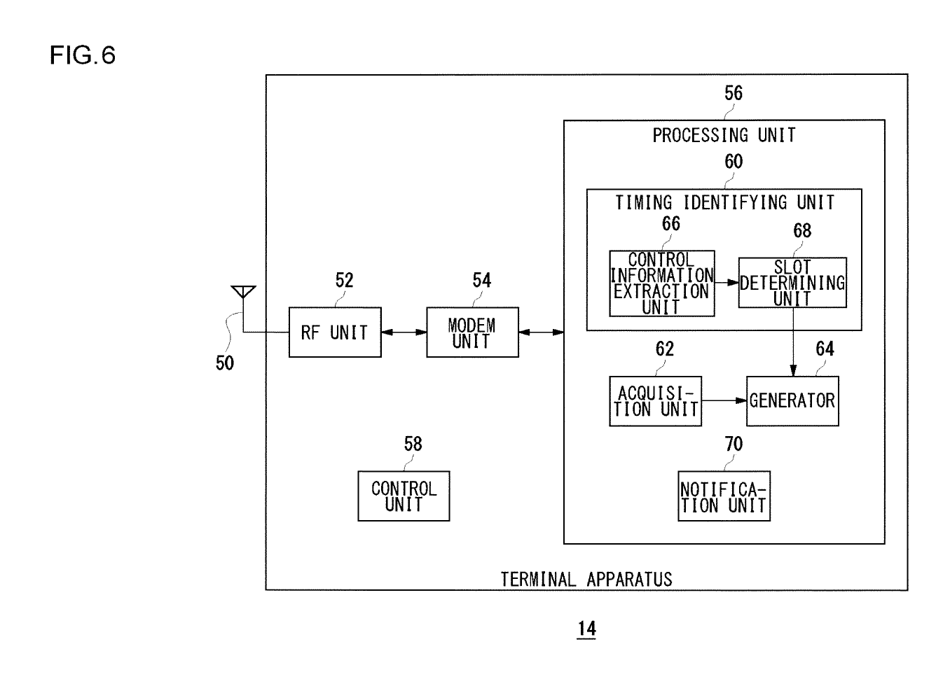

FIG. 6 shows a structure of a terminal apparatus 14 mounted on a vehicle 12. The terminal apparatus 14 includes an antenna 50, an RF unit 52, a modem unit 54, a processing unit 56, and a control unit 58. The processing unit 56 includes a timing identifying unit 60, an acquisition unit 62, a generator 64, and a notification unit 70. The timing identifying unit 60 includes a control information extraction unit 66 and a slot decision unit 68. The antenna 50, the RF unit 52 and the modem unit 54 carry out the processings similar to those carried out by the antenna 20, the RF unit 22 and the modem unit 24 of FIG. 2, respectively. Thus, the repeated description thereof is omitted here.

The acquisition unit 62 includes a GPS receiver, a gyroscope, a vehicle speed sensor, and so forth all of which are not shown in FIG. 6. The acquisition unit 62 acquires the present position, traveling direction, traveling speed and so forth of a not-shown vehicle 12, namely the vehicle 12 carrying the terminal apparatus 14, based on data supplied from the aforementioned not-shown components of the acquisition unit 62. The present position thereof is indicated by the latitude and longitude. Known art may be employed to acquire them and therefore the description thereof is omitted here. The acquisition unit 62 outputs the thus acquired information to the generator 64.

The control information extraction unit 66 receives the demodulation result fed from the modem unit 54. Of the demodulation result, the control information extraction unit 66 monitors a part of subcarriers corresponding to the identification carrier. If valid data is contained in the part of subcarriers corresponding to the identification carrier, the control information extraction unit 66 will recognize that the control information extraction unit 66 is receiving a slot containing the control information therein, namely a control slot. Also, the control information extraction unit 66 establishes the synchronization between frames and slots when the timing with which the slot containing the control information is received is used as a reference.

More specifically, the control information extraction unit 66 identifies the control slots where the received demodulation result is assigned, based on the information on control slots contained in the control information; then the control information extraction unit 66 generates frames with this identified control slot as a reference. Further, the control information extraction unit 66 acquires information on empty slots and information on collision slots, from the control information. The control information extraction unit 66 outputs the information on empty slots and the information on collision slots to the slot decision unit 68. Also, the control information extraction unit 66 outputs the information on control slots to the slot decision unit 68 as the control slot information and also outputs the identification information to the slot decision unit 68.

The slot decision unit 68 receives the information on empty slots and the information on collision slots, from the control information extraction unit 66. The slot decision unit 68 also receives the control slot information and the identification information from the control information extraction unit 66. The slot decision unit 68 selects one empty slot from among the slots excluding those of control region 220, based on the information on empty slots. Note that one empty slot may be selected arbitrarily. The slot decision unit 68 outputs the information on the selected empty slot, the control slot information and the identification information to the generator 64.

The generator 64 receives the information fed from the acquisition unit 62 and also receives the control slot information and the control information fed from the slot decision unit 68. The generator 64 generates data, based on said information wherein the data is formed as shown in FIG. 5B. Also, the generator 64 receives an instruction on the empty slot from the slot decision unit 68 and outputs the data to the modem unit 54 using the empty slot associated with the instruction. Note that the processing unit 56 may conduct carrier sense before the data is outputted. For the next frame, too, the generator 64 outputs the data using the slot of the same slot number.

While such processing continues, the control information extraction unit 66 continues to extract the information on empty slots and the information on collision slots, from the control information, frame by frame. Based on the information on collision slots, the slot decision unit 68 checks to see if any of the slot numbers corresponding to the slots in current use is mistakenly taken as a collision slot. If no slot is taken mistakenly as a collision slot, the slot decision unit 68 will continue to output the same slot numbers as before to the generator 64. If, on the other hand, any slot is mistakenly taken as a collision slot, the slot decision unit 68 will select again an empty slot based on the information on empty slots. In other words, another slot, which is different from the slot selected before, is now selected. The slot decision unit 68 outputs the information on the newly selected empty slot to the generator 64. From then onward, the generator 64 carries out the processing similar to that described above. The notification unit 70 acquires data sent from another terminal apparatus 14 (not shown) and informs a driver that another vehicle 12 is approaching and so forth. The processing carried out by the notification unit 70 is not limited thereto. The control unit 58 controls the entire operation of the terminal apparatus 14.

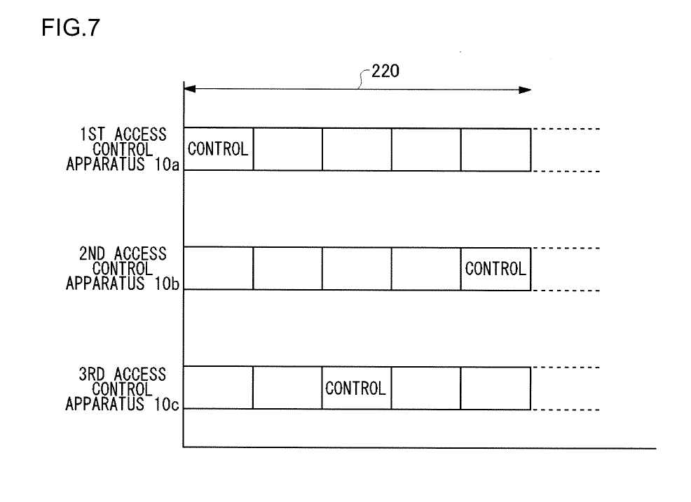

An operation of the communication system 100 configured as above is now described. FIG. 7 shows an operational overview of the communication system 100. The horizontal direction of FIG. 7 corresponds to time, and the first access control apparatus 10a to the third access control apparatus 10c are indicated along the vertical direction of FIG. 7. As described earlier, assumed herein that five control slots are assigned to the control region 220. “Control” in FIG. 7 indicates control information. The first access control apparatus 10a uses the leading control slot. The second access control apparatus 10b uses the fifth control slot. The third access control apparatus 10c uses the third control slot. As a result, the interference among the control information transmitted by broadcast from the respective access control apparatuses 10 is reduced.

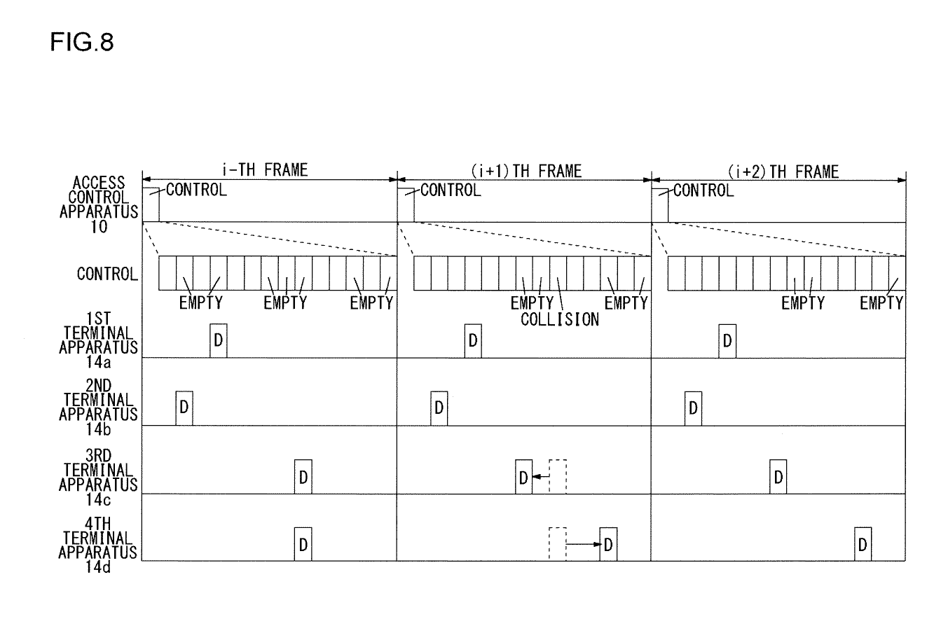

FIG. 8 is shows another operational overview of the communication system 100. The horizontal direction of FIG. 8 corresponds to time, and three frames that are an ith frame to an (i+2)th frame are indicated as described in the top row. Assume herein for the clarity of description that the number of control slots contained in each frame is one and

each frame contains 15 slots. As shown in FIG. 8, the access control apparatus 10 broadcasts the control information using the leading slot of each frame. “Control” in FIG. 8 indicates control information. Below “control”, information on empty slots and information on collision slots both contained in the control information are indicated by associating them with slots. “Empty” in FIG. 8 indicates an empty slot, whereas “collision” in FIG. 8 indicates a collision slot.

In the rows below the top row, the timings with which the first terminal apparatus 14a to the fourth terminal apparatus 14d broadcast the data are indicated. “D” in FIG. 8 means data. The first terminal apparatus 14a to the fourth terminal apparatus 14d each references the control information and selects an empty slot. The first terminal apparatus 14a to fourth terminal apparatus 14d each broadcasts the data using the selected empty slot in the ith frame. Since the empty slot selected by the third terminal apparatus 14c is identical to the empty slot selected by the fourth terminal apparatus 14d, the data broadcast from them collide with each other. The access control apparatus 10 detects the occurrence of collision in said slot. The control information, broadcast from the access control apparatus 10, in the (i+1)th frame indicates the slot where the collision occurs, as the information on the collision slot.

Since no collision occurs in the slots used by the first terminal apparatus 14a and the second terminal apparatus 14b, the slots having the same slot numbers are used again. On the other hand, since collision has occurred in the slots used by the third terminal apparatus 14c and the fourth terminal apparatus 14d, different empty slots are selected again. The third terminal apparatus 14c and the fourth terminal apparatus 14d broadcast data, using the selected empty slots. Since not all of data collides, the collision slots are not indicated in the control information, broadcast from the access control apparatus 10, in the (i+2)th frame. Thus, the first terminal apparatus 14a to the fourth terminal apparatus 14d use again the slots, having the same slot numbers as the slots used already, in the (i+2)th frame.

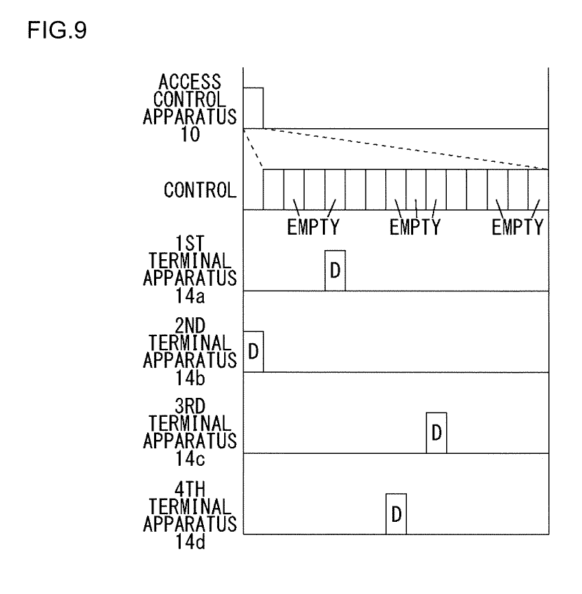

FIG. 9 shows another operational overview of the communication system 100. FIG. 9 is represented in a similar manner to FIG. 8. As a precondition in FIG. 7, the second terminal apparatus 14b is incapable of receiving the control information sent from the access control apparatus 10. Thus, the second terminal apparatus 14b transmits data without being aware of the frame construction. The access control apparatus 10 broadcasts the control information, using the leading slot in a frame. At the same time, the second terminal apparatus 14b broadcasts data, using the leading slot in a frame. As a result, the control information and the data collide in said slot. Even though the collision occurs, the first terminal apparatus 14a, the third terminal apparatus 14c and the fourth terminal apparatus 14d can detect the presence of control information by observing the signal components of identification carriers in the control information.

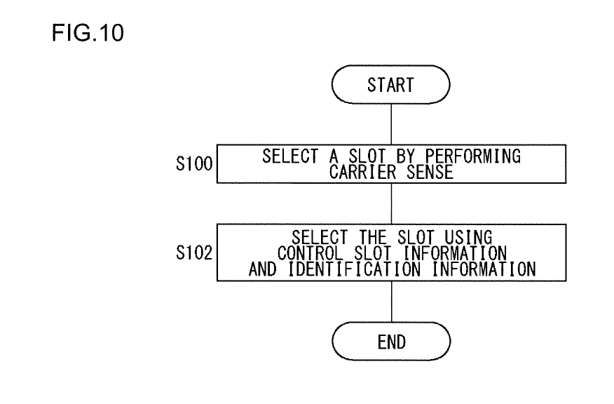

FIG. 10 is a flowchart showing a procedure in which the access control apparatus 10 selects a control slot. The carrier sensing unit 118 selects slots by performing carrier sense (S100). The carrier sensing unit 118, the analysis unit 114, the estimation unit 116 and the carrier sensing unit 118 select the slots using the control slot information and the identification information (S102).

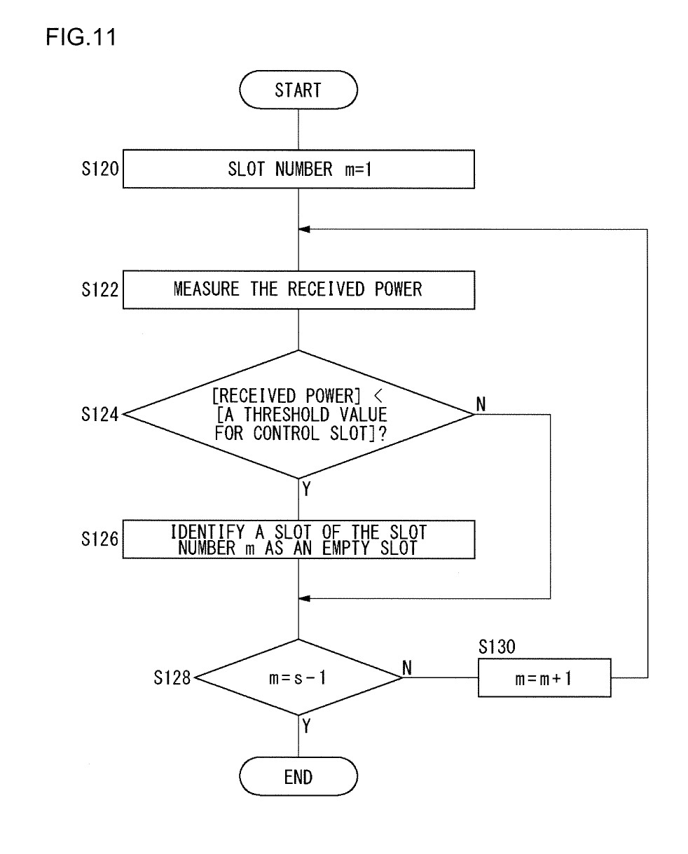

FIG. 11 is a flowchart showing a procedure in which a control slot is selected by performing carrier sense. FIG. 11 corresponds to Step S100 of FIG. 10. Assume that the number of control slots contained in the control region 220 is “s−1”. The carrier sensing unit 118 sets the slot number m to “1” (S120). The carrier sensing unit 118 measures the received power (S122). If the received power is less than the threshold value for control slot (Y of S124), the carrier sensing unit 118 will identify the slot of the slot number m as an empty slot (S126). If the received power is not less than the threshold value for control slot (N of S124), the carrier sensing unit 118 will skip the process of Step 5126. If the slot number m is not equal to the maximum number “s−1” (N of S128), the carrier sensing unit 118 will increment the slot number m by 1 (S130) and the process will return to Step S122. If, on the other hand, the slot number m is the maximum number “s−1” (Y of S128), the processing will be terminated.

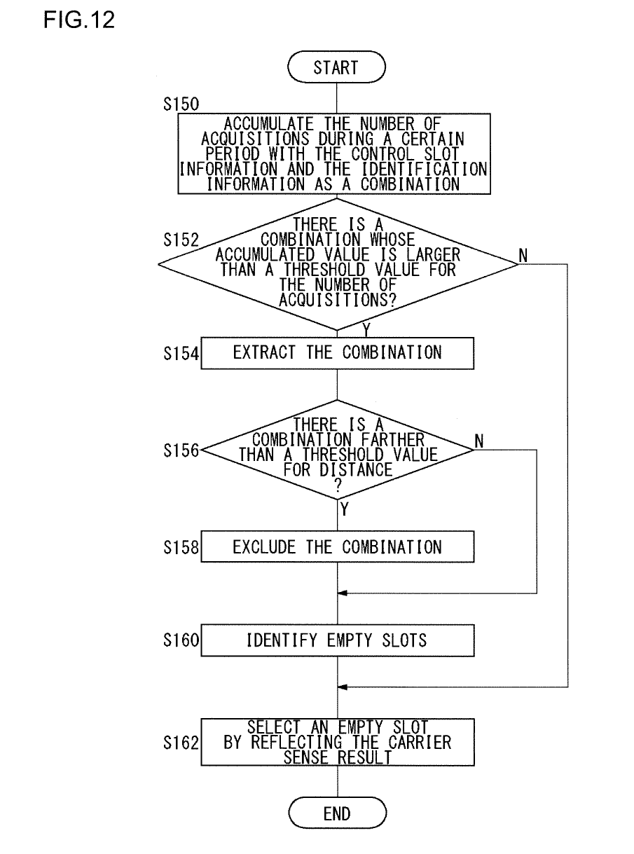

FIG. 12 is a flowchart showing a procedure in which a control slot is selected using the control slot information and the identification information. FIG. 12 corresponds to Step S102 of FIG. 10. The analysis unit 114 accumulates the number of acquisitions over a certain period of time with the control slot information and the identification as a combination (S150). If there is a combination or combinations whose number of acquisitions is larger than the threshold value for the number of acquisitions (Y of S152), the analysis unit 114 will extract said combination (S514). If there is a combination or combinations whose distance is larger (farther) than the threshold value for distance (S158), the analysis unit 114 will exclude said combination (N of S156). If there is no combinations whose distance is farther than the threshold value for distance (N of S156), Step 5158 will be skipped. The estimation unit 116 identifies empty slots (S160). If, on the other hand, there is no combinations whose number of acquisitions is larger than the threshold value for the number of acquisitions (N of S152), the processes of Step S154 to Step S160 will be skipped. The execution unit 120 will reflect the result of carrier sense so as to select a slot (S162).

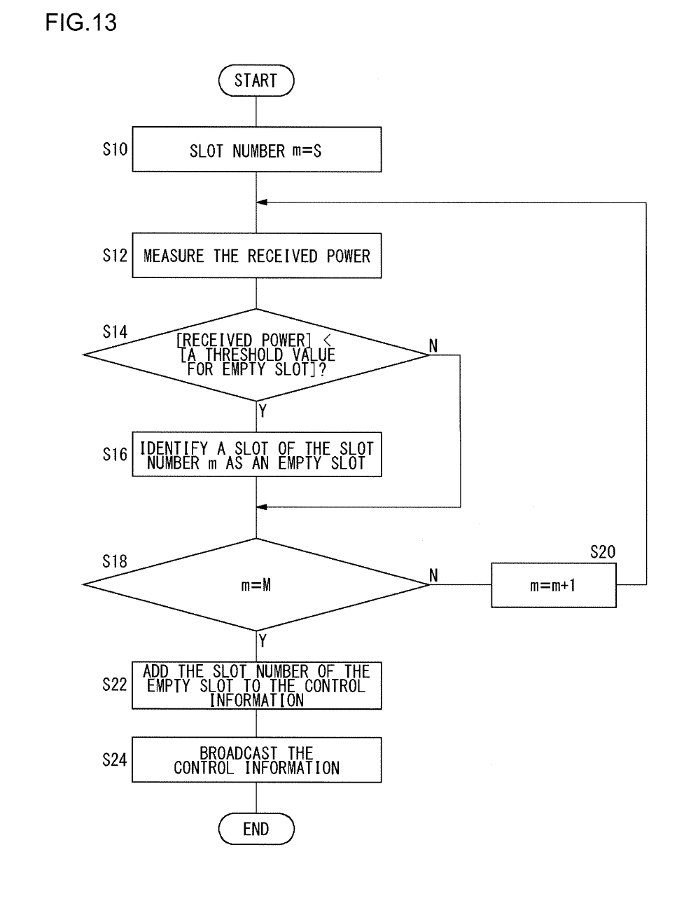

FIG. 13 is a flowchart showing a procedure in which the access control apparatus 10 conveys an empty slot. The detecting unit 32 sets the slot number m to “s” (S10). The power measuring unit 38 measures the received power (S12). If the received power is less than the threshold value for empty slot (Y of S14), the empty slot identifying unit 42 will identify the slot of the slot number m as an empty slot (S16). If the received power is not less than the threshold value for empty slot (N of S14), the empty slot identifying unit 42 will skip the process of Step S16. If the slot number m is not equal to the maximum number M (N of S18), the detecting unit 32 will increment the slot number m by 1 (S20) and the process will return to Step S12. If, on the other hand, the slot number m is the maximum number M (Y of S18), the generator 36 will add the slot number of the empty slot to the control information (S22). The modem unit 24 and the RF unit 22 broadcast the control information (S24).

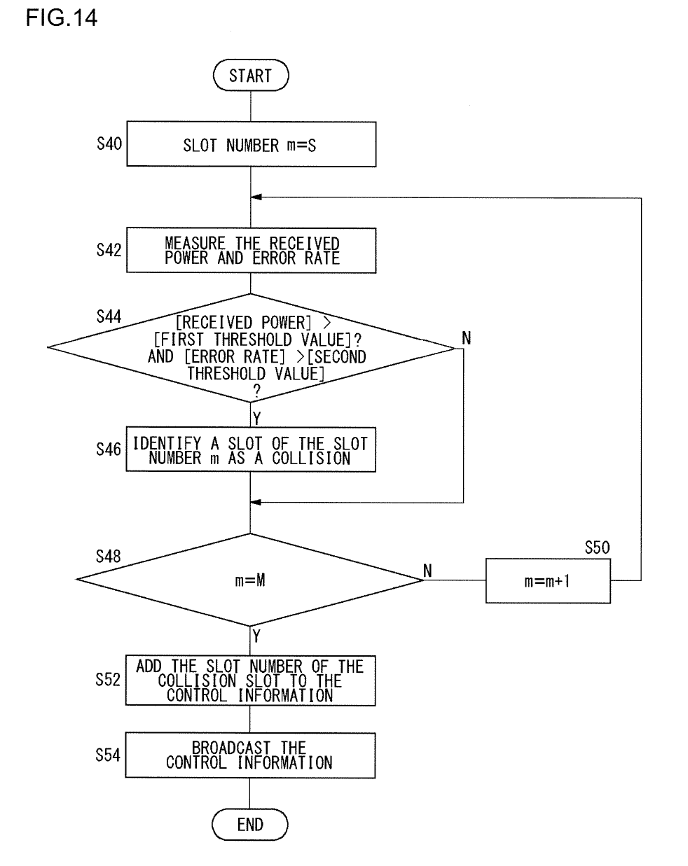

FIG. 14 is a flowchart showing a procedure in which the access control apparatus conveys a collision slot. The detecting unit 32 sets the slot number m to “s” (S40). The power measuring unit 38 measures the received power, and the quality measuring unit 40 measures the error rate (S42). If the received power is greater than the first threshold value and the error rate is greater than the second threshold value (Y of S44), the collision slot identifying unit 44 will identify the slot of the slot number m as a collision slot (S46). If the received power is not greater than the first threshold value or the error rate is not greater than the second threshold value (N of S44), the collision slot identifying unit 44 will skip the process of Step S46. If the slot number m is not equal to the maximum number M (N of S48), the detecting unit 32 will increment the slot number m by 1 (S50) and the process will return to Step S42. If, on the other hand, the slot number m is the maximum number M (Y of S48), the generator 36 will add the slot number of the collision slot to the control information (S52). The modem unit 24 and the RF unit 22 broadcast the control information (S54).

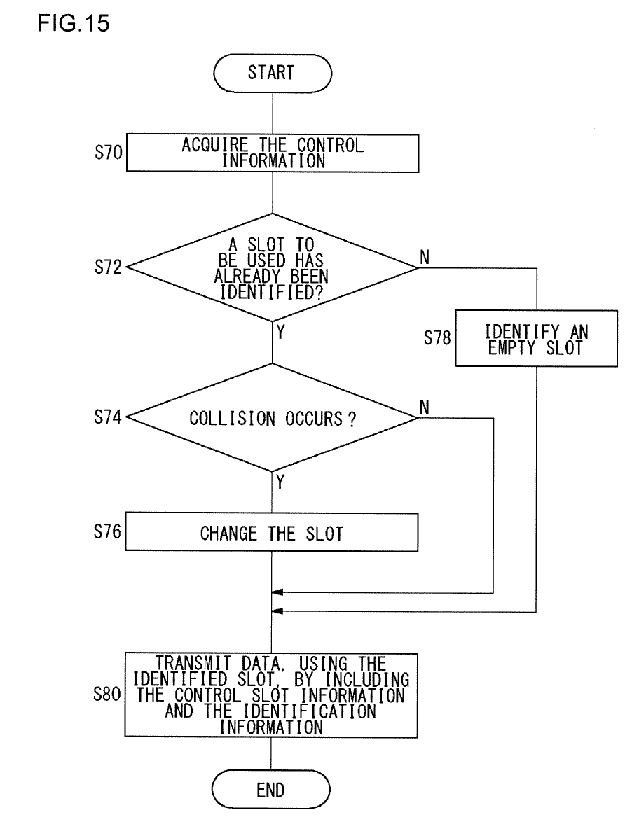

FIG. 15 is a flowchart showing a data transmission procedure performed by the terminal apparatus 14. The control information extraction unit 66 acquires the control information (S70). If a slot to be used has already been identified (Y of S72), the slot decision unit 68 will verify whether collision occurs in this slot or not. If collision occurs (Y of S74), the slot decision unit 68 will change the slot (S76). If no collision occurs (N of S74), Step S76 will be skipped. If, on the other hand, a slot to be used has not already been identified (N of S72), the slot decision unit 68 will identify empty slot(s) (S78). The generator 64 transmits data, using the thus identified slot (S80).

A modification is now described. Similar to the communication system 100 according to the exemplary embodiments, the communication system 100 according to the modification includes a plurality of access control apparatuses 10. The analysis unit 114 in the access control apparatus 10 according to the exemplary embodiments accumulates the combinations, namely performs statistical processing on the combinations, so as to identify empty control slots. In contrast thereto, the analysis unit 114 according to the modification does not perform statistical processing. The communication system 100 according to the modification is similar to those shown in FIG. 1 and FIG. 2. The access control apparatus 10 according to the modification is similar to that shown in FIG. 3, whereas the terminal apparatus 14 according to the modification is similar to that shown in FIG. 6.

The analysis unit 114 sequentially acquires combinations of identification information and control slot information from the information acquisition unit 112. The analysis unit 114 derives the position information from the identification information contained in the combinations. Also, the analysis unit 114 stores, in advance, the position information where the access control apparatus 10 is installed, and derives the distance between access control apparatuses based on their position information. Further, the analysis unit 114 stores beforehand the threshold value for distance, and compares the distance against the threshold value for distance. The analysis unit 114 excludes a combination for the access control apparatuses 10 whose distance is larger than the threshold value for distance, namely the combination for an access control apparatus 10 installed farther than said access control apparatus 10 by the threshold value for distance or greater. The analysis unit 114 outputs the remaining combinations to the to the estimation unit 116.

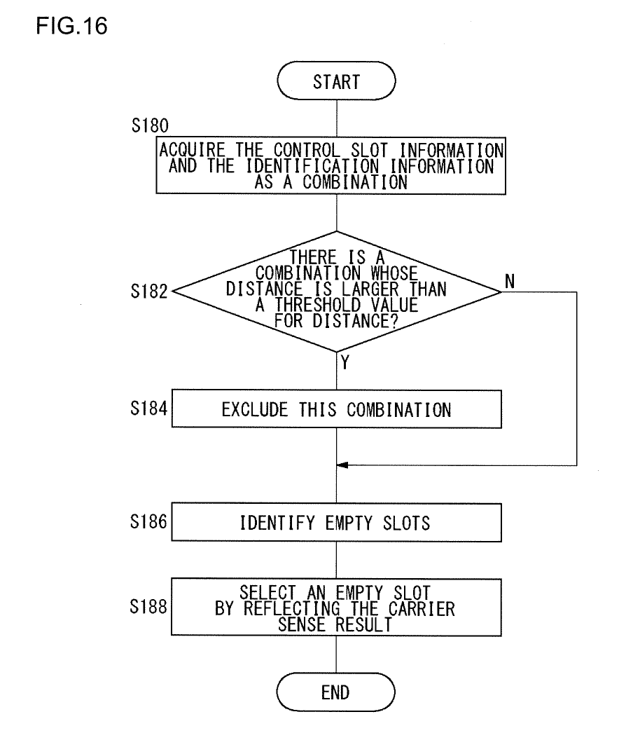

FIG. 16 shows a procedure, according to the modification of the exemplary embodiments of the present invention, in which a control slot is selected using the control slot information and the identification information. FIG. 16 corresponds to Step S102 of FIG. 10. The analysis unit 114 acquires the control slot information and the identification taken as a combination (S180). If there is a combination or combinations whose distance is larger (farther) than the threshold value for distance (Y of S182), the analysis unit 114 will exclude said combination (184). If there is no combinations whose distance is farther than the threshold value for distance (N of S182), Step 5184 will be skipped. The estimation unit 116 identifies empty slots (S186). The execution unit 120 will reflect the result of carrier sense so as to select a slot (S188).

By employing the exemplary embodiments of the present invention, the slots usable in communication between a plurality of terminal apparatuses are broadcast from among a plurality of slots. Thus the probability of collisions occurring in communication between the plurality of terminal apparatuses can be reduced. Also, since the probability of collisions occurring in communication between the plurality of terminal apparatuses is reduced, the collision probability of packet signals under the conditions of increased volume can be reduced. Also, empty slots are identified based on the received powers of a plurality of slots, respectively, so that the empty slots can be easily identified. Also, the slot number of an empty slot which is contained in a previous frame is broadcast, so that the instructions to the terminal apparatuses can be executed reliably. Also, a terminal apparatus, which is using the empty slot, uses a slot that corresponds to said slot, over a plurality of frames, so that the processing can be simplified. Also, the access control apparatus does not directly participate in the data communication between terminal apparatuses but only conveys a parameter related to the empty slots. Hence, the structure and operation according to the exemplary embodiments are easily applicable to a communication system premised on CSMA/CA, too.

Also, the slot in which a collision has occurred due to duplicate transmission of signals from the plurality of terminal apparatuses is broadcast. Thus, the probability of collisions occurring in communication between the plurality of terminal apparatuses can be reduced. Also, the collision slots are identified based on the received powers of the plurality of slots, respectively, and the signal qualities of the plurality of slots, respectively, so that the collision slots can be easily identified. Also, the slot number of a collision slot which is contained in a previous frame is broadcast, so that the instructions to the terminal apparatuses can be executed reliably. Also, the access control apparatus does not directly participate in the data communication between terminal apparatuses but only conveys a parameter related to the collision slots. Hence, the structure and operation according to the exemplary embodiments are easily applicable to a communication system premised on CSMA/CA, too.

Also, the identification carriers in the control information are not used for data, whereas the remaining subcarriers are also used for data. Thus, even if the control information and data signals collide with each other, the presence of the control information can be detected by observing the signal components of the control information. Also, the guard band is provided between the identification carrier and the other subcarriers, so that the interference therebetween can be reduced and the probability of arrival of information transmitted using the identification carrier can be improved. Also, important information is assigned to the identification carrier, so that the probability of arrival of important information can be improved. Also, the UW is assigned to the identification carrier, so that the degree of accuracy in detecting the identification carriers can be improved.

Also, the control region is used exclusively for control slots in a plurality of slots contained in each frame. Thus, the interference between the control information and the data can be reduced. Also, a plurality of control slots are assigned to the control region, so that the interference between a plurality of pieces of control information from a plurality of access control apparatuses can be reduced. Also, since the interference therebetween is reduced, the deterioration in the quality of the control information can be suppressed. Also, since the deterioration in the quality of the control information is suppressed, the contents of control information can be transmitted accurately. Also, since the contents of control information is accurately transmitted, the information on empty slots and the like can be conveyed accurately. Also, since the interference between a plurality of pieces of control information is reduced, a plurality of access control apparatuses can be installed. Also, since a plurality of access control apparatuses are installed, the collision probability of packet signals occurring at each intersection can be reduced. Also, control slots not used by other access control apparatuses are estimated, so that the interference between a plurality of pieces of control information can be reduced

Also, the information on a selected control slot and the identification information are added to the control information, so that the information on a selected control slot and the identification information can be conveyed to the terminal apparatus. Also, since the information on a selected control slot and the identification information are added to the control information, any of the plurality of control slots can be freely used. Also, since the information on a selected control slot and the identification information are received from the terminal apparatus, the presence of an access control apparatus which cannot be directly recognized can be recognized indirectly. Also, since the presence of an access control apparatus which cannot be directly recognized is recognized indirectly, the hidden node problem can be eliminated. Also, since the presence of an access control apparatus which cannot be directly recognized can be recognized indirectly, the accuracy in selecting a control slot can be improved. Also, since the accuracy in selecting a control slot is improved, the interference between multiple pieces of control information can be reduced.

Also, the statistical processing is performed on a combination of control slot information and identification information, so that the estimation accuracy of empty control slots can be improved. Also, an access control apparatus installed in a position far away from a given access control apparatus is excluded from those which are subjected to the statistical processing, so that the number of selectable control slots can be increased while the degradation of quality due to the interference is being suppressed. Since the number of selectable control slots is increased, the degree of freedom in selecting the control slot or slots can be improved. Also, control slots which are not used by access apparatuses other than the access apparatus installed far away therefrom are selected, so that the interference between multiple pieces of control information can be reduced.

The present invention has been described based on the exemplary embodiments. The exemplary embodiments are intended to be illustrative only, and it is understood by those skilled in the art that various modifications to constituting elements and processes as well as arbitrary combinations thereof could be further developed and that such modifications and combinations are also within the scope of the present invention.

In the exemplary embodiments of the present invention, the frame specifying unit 34 specifies frames each of which is constituted by a plurality of slots. However, this should not be considered as limiting and, for example, the frame specifying unit 34 may provide periods (fields) other than the plurality of slots, in each frame. More specifically, a plurality of slots may be assigned in a partial period of a frame, whereas the CSMA/CA method may be used in communication between a plurality of terminal apparatuses 14 in the remaining periods. In such a case, the access control apparatus 10 does not detect the empty slots and the collision slots while the CSMA/CA method is in use. According to this modification, each terminal apparatus 14 can select the communication mode between a communication using slots and a communication using the CSMA/CA method. Hence, the degree of freedom in communications can be increased. In other words, it suffices that each frame contains a plurality of slots.

In the exemplary embodiments of the present invention, the control information broadcast from the access control apparatus 10 and the data broadcast from a terminal apparatus 14 are each assigned to a single slot. However, this should not be considered as limiting and, for example, the control information and the data may each be assigned to two or more slots. According to this modification, the transmission rate of control information and data can be increased.

In the exemplary embodiments of the present invention, an identification carrier is equivalent to two subcarriers. Also, the identification carrier is assigned to the subcarriers near the center frequency of an OFDM symbol. However, this should not be considered as limiting and, for example, the identification carrier may be equivalent to two or more subcarriers. For example, the identification carrier may be assigned to subcarriers other than those near the center frequency of an OFDM symbol. In such a case, the information on empty slots and the information on collision slots may be added to the identification carrier. According to this modification, the communication system 100 can be designed more freely.

In the exemplary embodiments of the present invention, the identification information of the access control apparatus 10 is associated with the position information of the access control apparatus 10. However, this should not be considered as limiting and, for example, the identification information thereof may be assigned without reference to the position information thereof. According to this modification, the degree of freedom in assigning the identification information can be improved. In other words, different identification information may be assigned to different access control apparatuses 10, respectively.

### DESCRIPTION OF THE REFERENCE NUMERALS

10 Access control apparatus

12 Vehicle

14 Terminal apparatus

20 Antenna

22 RF unit

24 Modem unit

26 Processing unit

28 GPS positioning unit

30 Control unit

32 Detecting unit

34 Frame specifying unit

36 Generator

38 Power measuring unit

40 Quality measuring unit

42 Empty slot identifying unit

44 Collision slot identifying unit

50 Antenna

52 RF unit

54 Modem unit

56 Processing unit

58 Control unit

60 Timing identifying unit

62 Acquisition unit

64 Generator

66 Control information extraction unit

70 Notification unit

100 Communication system

110 Selection unit

112 Information acquisition unit

114 Analysis unit

116 Estimation unit

118 Carrier sensing unit

120 Execution unit

### INDUSTRIAL APPLICABILITY

The present invention reduces the collision probability of packet signals even when the communication volume has increased.

1. An access control apparatus for controlling communications between radio apparatuses, the access control apparatus comprising:
a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
a selection unit configured to select a slot from among the part of the plurality of slots wherein said slot selected by said selection unit is used to broadcast information on the slot detected by said detecting unit; and
a broadcasting unit configured to broadcast information on the slot detected by said detecting unit, using the slot selected by said selection unit.

2. An access control apparatus according to claim 1, further comprising an estimation unit configured to estimate a slot not used by other access apparatuses, in the part of the plurality of slots,
wherein said selection unit selects the slot based on an estimation result obtained by said estimation unit.

3. A broadcasting method in an access control apparatus that controls communications between radio apparatuses, the broadcasting method comprising:
detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
selecting a slot from among the part of the plurality of slots in order to broadcast information on the detected slot; and
broadcasting information on the detected slot detected, using the selected slot.

4. An access control apparatus for controlling communications between radio apparatuses, the access control apparatus comprising:
a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
a selection unit configured to select a slot from among the part of the plurality of slots in order to broadcast empty slot information on the slot detected by said detecting unit; and
a broadcasting unit configured to broadcast the empty slot information and identification information by which to identify the access control apparatus, using the slot selected by said selection unit.

5. An access control apparatus according to claim 4, further comprising:
a receiver configured to receive from a radio apparatus a signal, used in communications between radio apparatuses, which contains (i) the identification information of an access control apparatus that has broadcast the empty slot information referenced by the radio apparatus and (ii) broadcast slot information on a slot through which the empty slot information referenced by the radio apparatus has been broadcast; and
an estimation unit configured to estimate slots not used by other access apparatuses in the part of the plurality of slots, based on the identification information and the broadcast slot information contained in the signal received by said receiver,
wherein said selection unit selects the slot based on an estimation result obtained from said estimation unit.

6. A radio apparatus for broadcasting a signal to other radio apparatuses, the radio apparatus comprising:
a receiver configured to receive from an access apparatus, a signal that contains (1) empty slot information on slots usable in communication between radio apparatuses and (2) identification information by which to identify the access control apparatus which is a broadcasting source, using a slot contained in a plurality of slots which are contained in a frame, a part of which are reserved for use on the access control apparatus, wherein it is specified in a manner such that the frame containing at least a plurality of slots is repeated;
a selection unit configured to select a slot from among the remaining part of the plurality of slots, based on the empty slot information contained in the signal received by said receiver; and
a broadcasting unit configured to broadcast the signal by adding (1) the identification information contained in the signal received by said receiver and (2) broadcast slot information on a slot through which the signal received by said receiver has been broadcast.

7. A broadcasting method in an access control apparatus that controls communications between radio apparatuses, the broadcasting method comprising:
detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
selecting a slot from among the part of the plurality of slots in order to broadcast empty slot information on the selected slot; and
broadcasting the empty slot information and identification information by which to identify the access control apparatus, using the selected slot.

8. A broadcasting method in a radio apparatus that broadcasts a signal to other radio apparatuses, the broadcasting method comprising:
receiving from an access apparatus, a signal that contains (1) empty slot information on slots usable in communication between radio apparatuses and (2) identification information by which to identify the access control apparatus which is a broadcasting source, using a slot contained in a plurality of slots which are contained in a frame, a part of which are reserved for use on the access control apparatus, wherein it is specified in a manner such that the frame containing at least a plurality of slots is repeated;
selecting a slot from among the remaining part of the plurality of slots, based on the empty slot information contained in the received signal; and
broadcasting the signal by adding (1) the identification information contained in the received signal and (2) broadcast slot information on a slot through which the received signal has been broadcast.

9. An access control apparatus for controlling communications between radio apparatuses, the access control apparatus comprising:
a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
a selection unit configured to select a slot from among the part of the plurality of slots in order to broadcast empty slot information on the slot detected by said detecting unit; and
a broadcasting unit configured to broadcast the empty slot information and identification information by which to identify said access control apparatus, using the slot selected by said selection unit,
said selection unit including:
an acquisition unit configured to receive from a radio apparatus a signal, used in communications between radio apparatuses, which contains (i) the identification information of an access control apparatus that has broadcast the empty slot information referenced by the radio apparatus and (ii) broadcast slot information on a slot through which the empty slot information referenced by the radio apparatus has been broadcast;
an analysis unit configured to statistically analyze the identification information and the broadcast slot information contained in the signal received by the acquisition unit;
an estimation unit configured to estimate slots not used by other access apparatuses in the part of the plurality of slots, based on an analysis result derived by the analysis unit; and
an execution unit configured to select a slot based on an estimation result of the estimation unit.

10. An access control apparatus according to claim 9, wherein the identification information contained in the signal received by the acquisition unit corresponds to positional information on the access control apparatus installed, and
wherein the identification information and the broadcast slot information for an access control information apparatus installed in a position far away from said access control apparatus are excluded from the analyzing done by the analysis unit.

11. An access control apparatus for controlling communications between radio apparatuses, the access control apparatus comprising:
a detecting unit configured to detect a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
a selection unit configured to select a slot from among the part of the plurality of slots in order to broadcast empty slot information on the slot detected by said detecting unit; and
a broadcasting unit configured to broadcast the empty slot information and identification information by which to identify said access control apparatus, using the slot selected by said selection unit,
said selection unit including:
an acquisition unit configured to receive from a radio apparatus a signal, used in communications between radio apparatuses, which contains (i) position information indicating where an access control apparatus that has broadcast the empty slot information referenced by the radio apparatus is installed and (ii) broadcast slot information on a slot through which the empty slot information referenced by the radio apparatus has been broadcast
an estimation unit configured to estimate slots not used by other access apparatuses located in a neighborhood of said access control apparatus, based on identification information and the broadcast slot information contained in the signal received by the acquisition unit; and
an execution unit configured to select a slot based on an estimation result of the estimation unit.

12. A broadcasting method in an access control apparatus that controls communications between radio apparatuses, the broadcasting method comprising:
detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
selecting a slot from among the part of the plurality of slots in order to broadcast empty slot information on the detected slot; and
broadcasting the empty slot information and identification information by which to identify the access control apparatus, using the selected slot,
said selecting including:
receiving from a radio apparatus a signal, used in communications between radio apparatuses, which contains (i) the identification information of an access control apparatus that has broadcast the empty slot information referenced by the radio apparatus and (ii) broadcast slot information on a slot through which the empty slot information referenced by the radio apparatus has been broadcast;
analyzing statistically the identification information and the broadcast slot information contained in the received signal;
estimating slots not used by other access apparatuses in part of the plurality of slots, based on an analysis result derived the analyzing; and
selecting a slot based on an estimation result obtained by the estimating.

13. A broadcasting method in an access control apparatus that controls communications between radio apparatuses, the broadcasting method comprising:
detecting a slot, which is usable for the communications between radio apparatuses, from among a plurality of slots, contained in a frame, excluding a part of the plurality slots which are reserved for use on an access control apparatus, wherein it is specified in a manner such that the frame containing at least a plurality of slots is repeated;
selecting a slot from among the part of the plurality of slots in order to broadcast empty slot information on the detected slot; and
broadcasting the empty slot information and identification information by which to identify the access control apparatus, using the selected slot,
said selecting including:
receiving from a radio apparatus a signal, used in communications between radio apparatuses, which contains (i) position information indicating where an access control apparatus that has broadcast the empty slot information referenced by the radio apparatus is installed and (ii) broadcast slot information on a slot through which the empty slot information referenced by the radio apparatus has been broadcast
estimating slots not used by other access apparatuses located in a neighborhood of the access control apparatus, based on identification information and the broadcast slot information contained in the received signal; and
selecting a slot based on an estimation result derived by the estimating.
